(19) United States
(12) Patent Application Publication
(10) Pub. No.: US 2022/0030890 A1
(43) Pub. Date: Feb. 3, 2022

(54) RELEASE AGENT FOR FOOD NETTING, AND RELATED TREATED NETTING AND METHODS

(71) Applicant: Viskase Companies, Inc., Lombard, IL (US)

(72) Inventors: Myron D. Nicholson, Lemont, IL (US); Ann Dinh-Sybeldon, Woodridge, IL (US)

(21) Appl. No.: 17/298,792

(22) PCT Filed: Nov. 27, 2019
(86) PCT No.: PCT/US2019/063666

§ 371 Date: Jun. 1, 2021

Related U.S. Application Data
(60) Provisional application No. 62/774,781, filed on Dec. 3, 2018.

(51) Int. Cl. A22C 13/00

(52) U.S. Cl. CPC A22C 13/0013; A22C 2013/0056

(57) ABSTRACT

Release agent compositions for treating food netting include hydrophilic (e.g., acidic) and hydrophobic (e.g., surface active amphiphilic modifier, oil) components that both enhance the releasability of a food product from the treated netting material. The acid of the release agent composition denatures proteins along an outer surface of the food article, forming a skin of insolubilized proteins between the netting material and the remainder of the food product. This protein skin, along with the oil, if present, and a surface active amphiphilic modifier of the release agent, inhibit absorption and/or adsorption of hydrophilic food proteins from the food product into or onto the netting, which inhibits strong mechanical binding between the netting and the food product. Subsequent release of the netting from the food product is relatively easy, without damaging the food product itself. Related articles and methods are also disclosed.

### CROSS-REFERENCE TO RELATED APPLICATIONS

This application is a national phase entry under 35 U.S.C. § 371 of International Patent Application PCT/US2019/063666, filed Nov. 27, 2019, designating the United States of America and published as International Patent Publication WO 2020/117595 A1 on Jun. 11, 2020, which claims the benefit under Article 8 of the Patent Cooperation Treaty to U.S. Patent Application Ser. No. 62/774,781, filed Dec. 3, 2018.

### TECHNICAL FIELD

Embodiments of the present disclosure generally relate to food netting release agents. More particularly, this disclosure relates to release agent compositions for treating food netting, to treated food netting, to methods for forming the release agents, and to methods for treating food netting with the release agents.

### BACKGROUND

Netting material is sometimes used to secure food products, such as meat, poultry, cheese, or the like food products. These “food netting” articles may be used to not only secure the food product, but may also impart flavoring and topographical decoration to the food product.

The food netting may secure the food products when the food products are aged, stored, sold, and/or cooked. Removing the food netting from the food product may be the job of the food retailer or, in some cases, the end consumer.

Conventional food netting articles often tend to adhere strongly to the netted food product, making the removal of the food netting a time consuming challenge. In commercial settings, where workers are tasked with removing the food netting from food products as a repetitive work task, time consuming and challenging food netting removal may not only lower worker efficiency, but may wear on the worker, leading to conditions of the likes of carpal tunnel syndrome.

Efforts have been made to formulate and apply release agents to food netting to enable easier removal of the food netting from the food product. Nonetheless, formulating release agents to achieve sufficient releasability (e.g., peelability of the netting from the food product in a timely manner), while not damaging the food product (e.g., tearing away chunks of the food product along with the netting material) and while not degrading the netting material or the food product (e.g., detracting from or otherwise negatively impacting the taste or look of the food product), continues to present challenges.

### BRIEF SUMMARY

Disclosed is a composition for a release agent for food netting. In at least some embodiments, the composition comprises at least one acid and at least one of a surface active amphiphilic modifier or a surfactant.

Also disclosed is a treated netting for food products. In at least some embodiments, the treated netting comprises a netting material and a composition on or in the netting material. The composition comprises at least one acid and at least one of a surface active amphiphilic modifier or a surfactant.

In addition, disclosed is a method for treating a food netting with a release agent. In at least some embodiments, the method comprises applying a composition on material of a food netting before receiving a food product within the food netting. The composition comprises at least one acid and at least one of a surface active amphiphilic modifier or a surfactant.

Moreover, disclosed is a method of forming a release agent for food netting. In at least some embodiments, the method comprises forming a mixture of hydrophilic components comprising at least one acid. A mixture of hydrophobic components is also formed, the hydrophobic components comprising at least one surface active amphiphilic modifier. The mixture of hydrophilic components is combined with the mixture of hydrophobic components to form an emulsion of release agent.

### BRIEF DESCRIPTION OF THE DRAWINGS

FIG. 1 is a top view of a netted food product with a netting treated by a release agent, according to an embodiment of the disclosure.

FIG. 2 is a cross-sectional, elevational, schematic illustration of netting on a food product, the netting having been treated by a release agent, according to an embodiment of the present disclosure.

### DETAILED DESCRIPTION

Release agent compositions are disclosed herein along with food netting articles treated with such release agents, food products comprising netting treated with such release agents, and methods for making the release agents and for treating the netting. The release agents, according to embodiments of the disclosure, include components (e.g., hydrophilic, acidic components) that act upon the surface of the netted food product to insolubilize proteins thereof and also include components (e.g., hydrophobic components) that accommodate separation of fibrous netting material from cooked food products. The acidic components denature proteins on the surface of the netted food product, making the proteins insoluble, which may inhibit the proteins from absorbing into, or adsorbing onto, the fibers of the netting material in a manner that would bind the netting material to the food product itself. The hydrophobic components may further enable and enhance the ability to separate the netting material from the food product. Treated netting, according to embodiments of the disclosure, may ease separation of the netting from the food product in a faster time and with less needed manipulation of the netting and food product by the individual tasked with removing the netting.

As used herein “release agent” refers to a composition formulated to enable separation of one material from another. A “release agent” may otherwise be referred to herein, or known in the art as, a “peeling agent.”

As used herein “food netting” refers to a fibrous article for surrounding or encasing a food product. Food netting, according to the disclosure, may define openings (e.g., as in “open-type” food netting) or may not define openings (e.g., as in “closed-type” food netting). The fibers forming the food netting may or may not be natural fibers.

As used herein, the terms “about” and “approximately,” when either is used in reference to a numerical value for a particular parameter, are inclusive of the numerical value and a degree of variance from the numerical value that one of ordinary skill in the art would understand is within acceptable tolerances for the particular parameter. For example, “about” or “approximately,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the terms “comprises,” “comprising,” “includes,” and/or “including” specify the presence of stated components, chemicals, ingredients, and/or materials, but do not preclude the presence or addition of one or more other components, chemicals, ingredients, and/or materials.

As used herein, “and/or” includes any and all combinations of one or more of the associated listed items.

As used herein, the singular forms “a,” “an,” and “the” are intended to include the plural forms as well, unless the context clearly indicates otherwise.

As used herein, the terms “formulated” and “formula” mean and refer to a composition of referenced components, chemicals, or ingredients so as to facilitate a referenced characteristic, property, or effect of the referenced composition in a predetermined way.

As used herein, the terms “configured” and “configuration” mean and refer to a size, shape, material composition, orientation, and arrangement of a referenced material, structure, assembly, or apparatus so as to facilitate a referenced operation or property of the referenced material, structure, assembly, or apparatus in a predetermined way.

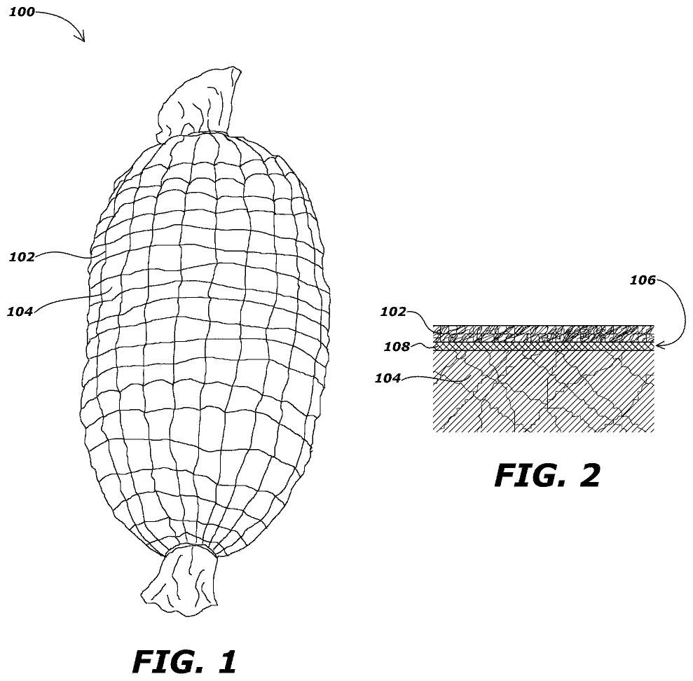

With reference to FIG. 1, illustrated is an example of a netted food product 100. FIG. 1 illustrates the netted food product 100 either before or after cooking, but before separation of netting 102 from a food product 104. In some embodiments in which FIG. 1 illustrates the netted food product 100 after cooking, it would be understood that the netted food product 100 before cooking may look similar, though perhaps somewhat expanded prior to cooking down the food product 104.

The netting 102 is treated with a release agent according to embodiments of the disclosure. The netting 102 may have been treated with the release agent prior to the netting 102 being applied to encase the food product 104 (e.g., prior to stuffing the netting 102 with the food product 104). In other embodiments, the netting 102 may have been treated with the release agent after the food product 104 was inserted within the netting 102.

The netting 102 may be formed of a fibrous material. For example, the netting 102 may be formed of natural fibers (e.g., cotton, wood, cellulose, hemp cellulose, flax, or the like), of synthetic fibers (e.g., polyester, rayon, or the like), or any other generally fibrillary, hydrophilic surface (e.g., paper, textile, or the like). In some embodiments, the netting 102 may, optionally, include elastic additives (e.g., natural or synthetic rubber thread).

The netting 102 may be open-type netting, as illustrated in FIG. 1, in which the food product 104 is visible through openings defined in the netting 102. Alternatively, the netting 102 may be a closed-type netting (e.g., “bubble” netting, stockinette), in which the food product 104 may be wholly covered or less visible through fiber lines of the netting 102. FIG. 1 may equally be construed as illustrating an alternative, bubble, closed-type netting, with the exception that the reference line for the food product 104 would not be directed to the visible surface of the netted food product 100, but to the underlying food product 104, which may be nonetheless visible (e.g., if the netting 102 is translucent) or nonvisible (e.g., if the netting 102 is opaque), though not as much exposed to the surroundings of the netted food product 100 as in an open-type netting embodiment. The type of netting may be selected depending on the food product 104 to be enclosed within the netting 102.

Without treatment of the release agents of the disclosure, the netting 102 may be generally absorbent or adsorbent to proteins of the food product 104. With treatment by a release agent of the disclosure, the netting 102 may less absorbent and/or less adsorbent to the proteins of the food product 104, resulting in less of a mechanical adhesion or bonding between the food product 104 and the material of the netting 102, enabling separation of the netting 102 from the food product 104 with less effort (e.g., less manual force and/or less time).

Prior to insertion of the food product 104 within the netting 102, the netting 102 may be treated (e.g., by dipping, coating, spraying (e.g., from the outside of the netting 102), or the like) the material of the netting 102 with the release agent in liquid form. The netting 102 may be treated with enough of the release agent composition so that the netting 102, once treated, may hold between about one times (1×) (e.g., a 100% increase in weight, relative to the weight of the netting 102 before treatment with the release agent) and about two-and-three-quarters times (2.75×) (e.g., a 275% increase in weight, relative to the weight of the netting 102 before treatment with the release agent) its weight due to the added release agent. In some embodiments, at least the 100% increase in weight may ensure an effective amount of the release agent is present in the treated netting 102 to enable improved releasability, while the less than the 275% increase in weight may ensure the resulting taste of the food product 104 is not degraded by the presence of the release agent.

Before, after, or both before and after treatment with the release agent, the netting 102 may be prepared for stuffing with the food product 104. For example, the netting 102—after treatment with the release agent—may be folded, wound, reeled, shirred, rucked, or otherwise prepared for later enclosing (e.g., “netting”) the food product 104. The release agent may be formulated to ensure the netting 102, once treated with the release agent, is not so cohesive that folds of the netting 102 will overly stick to one another and is not so slippery that the slickness of the treated netting 102 would inhibit effectively running the netting 102 through commercial equipment to stuff the food product 104 within the netting 102.

In embodiments in which the netting 102 is treated with the release agent prior to netting the food product 104, the netting 102 may contain the release agent on or within the material of the netting 102 at the time the netting 102 is stored, transported, or otherwise readied for enclosing the food product 104. In other embodiments, the netting 102 may be stored without containing any of the release agent, and the release agent may be added to the netting 102 during the process of stuffing the netting 102 with the food product 104, and/or even after stuffing the netting 102 with the food product 104.

Once the netting 102 is in place on the food product 104 and with the release agent loaded into and/or onto the material of the netting 102, the effects of the release agent on the food product 104 may begin. In some embodiments, the effect may begin even before cooking of the food product 104, without additional treatment of the netting 102, and without application of external energy (e.g., a heat source). For example, denaturization of the proteins on the surface of the food product 104 may begin prior to cooking. In some embodiments, protein denaturization may begin at room temperature (e.g., about 20° C. to about 25° C.).

The food product 104 may or may not be heated at the time of insertion of the food product 104 into the netting 102. The food product 104 may be cooked, par-cooked, or uncooked at the time it is inserted into the netting 102. For example, the food product 104 may be at about 40° C. when inserted into the netting 102, and the denaturization of proteins on the surface of the food product 104 may begin immediately or soon after contact between the netting 102 and the surface of the food product 104.

With reference to FIG. 2, schematically illustrated is a portion of the food product 104 with the netting 102, already treated with the release agent, in place. Contact between the release agent in the netting 102 and proteins of the food product 104 at a surface (e.g., an outer surface 106) of the food product 104 cause the proteins to denature, become insoluble, and may form a “protein skin” 108 at the outer surface 106, i.e., along an interface between the food product 104 and the netting 102. Subsequent cooking of the food product 104 within the netting 102 that has been treated with the release agent may further denature proteins of the food product 104 and enhance the protein skin 108.

The protein skin 108 may remain on the food product 104 after removal of the netting 102. In some embodiments, the protein skin 108 may remain on the food product 104 for consumption. In other embodiments, prior to consumption, the protein skin 108 may be removed.

The protein skin 108 on the outer surface 106 of the food product 104 may enable a greater retention of the internal juices of the food product 104, e.g., during and after storage and/or during and after cooking, than compared to the food product 104 without formation of the protein skin 108 prior to cooking. Therefore, it is contemplated that the food product 104 resulting from encasement with the netting 102 treated with the release agent of the disclosure may exhibit increased moisture levels relative to the same food product 104 absent exposure to the release agent.

The protein skin 108 may form at all of, a majority of, or at least part of the portion of the outer surface 106 of the food product 104 that comes into contact with the netting 102 treated with the release agent. In embodiments in which the netting 102 is a closed-type netting material wholly encasing the food product 104, the protein skin 108 may form along a whole of the outer surface 106 of the food product 104. Alternatively, in embodiments in which the netting 102 is formed of an open-type netting material or (e.g., due to shape of the food product 104) does not wholly contact the outer surface 106 of the food product 104, the protein skin 108 may form along only a portion of the outer surface 106, e.g., where the food product 104 contacted the release agent of the netting 102. In other embodiments, the portions of the outer surface 106 forming the protein skin 108 may extend beyond portions of the outer surface 106 where the food product 104 interfaces with the netting 102.

In embodiments in which the netting 102 was treated with the release agent prior to enclosing the food product 104 in the netting 102, no additional release agent may be applied to the netting 102 or to the food product 104 after stuffing of the netting 102. In other embodiments in which the netting 102 was treated with the release agent prior to enclosing the food product 104 in the netting, an additional amount of the release agent may be applied to the netting 102, to the outer surface 106 of the food product 104, or to both after the stuffing of the netting 102 but, e.g., before cooking, shipping, storing, selling, or removing the netting 102.

The denaturization of the proteins along the outer surface 106 of the food product 104 insolubilizes the proteins, inhibiting the insolubilized proteins from penetrating into or otherwise adhering onto the material of (e.g., the fibers of) the netting 102. Without the penetration of the proteins into the netting 102, the netting 102 may exhibit less adhesion between the food product 104 and the netting 102 than if the netting 102 had not been treated with the release agent. Thus the separation of the netting 102 from the food product 104 may be eased. Removal of the netting 102 from the food product 104 (e.g., after cooking, before consumption of the food product 104) may be a significantly easier and faster task, and with less damage to the food product 104, than compared to removal of the netting 102 had it not been treated with the release agent or had it been treated with a conventional release agent. For example, it is expected that treating the netting 102 with the release agent of embodiments of the disclosure may enable complete and clean removal of the netting 102 from the food product 104 (e.g., after cooking) with often no more than one cut along the length of a tube of the netting 102 and one pull of the netting 102 away from the food product 104, a surprisingly easier removal than forceful and repetitive turns and rips of untreated or conventionally treated netting from food product.

Netting treated with the release agent of embodiments of the disclosure may be capable of being stored, with or without enclosed food product, for at least six months without the release agent degrading the material of the netting 102 or, if enclosed, the food product 104. For example, the release agent may be formulated such that, during the shelf life, the release agent may not degrade, chemically breakdown, or otherwise negatively alter the performance characteristics (e.g., strength, elasticity, and the like) of the material of the netting 102. And, the release agent may be formulated such that, during the shelf life, the components of the release agent may not become inedible or unsafe for consumption and may not discolor, disfavor, or degrade the food product 104 itself.

To achieve the aforementioned results, the release agent, according to embodiments of the disclosure, may comprise hydrophobic and hydrophilic components, blended into an emulsion with the aid of at least one surface active amphiphilic modifier, at least one surfactant, or both. More particularly, the release agent may comprise, in addition to the at least one of the surface active amphiphilic modifier or the surfactant, at least one acid, optionally at least one oil, and optionally a thickening agent. Optionally, additional additives, such as colorants, flavorants, and/or the like may be included in the release agent.

Acid:

The acid of the release composition may serve to denature and insolubilize proteins at the outer surface 106 of the food product 104 when the netting 102, already treated with the release agent, comes into contact with the food product 104. More particularly, the acid denatures the otherwise-soluble food proteins on the outer surface 106 of the food product 104 (e.g., on the food contact surface), causing the proteins to precipitate (e.g., coagulate, cross-link, solidify) and form the protein skin 108, at least where the netting 102—having been treated with the release agent—contacts the outer surface 106 of the food product 104. The protein skin 108 may provide a barrier that inhibits or prevents the absorption and/or adsorption of remaining soluble protein, from the food product 104, into and/or onto the material (e.g., the fibers) of the netting 102. By inhibiting or preventing the absorption and/or adsorption of the proteins into and/or onto the material of the netting 102, the food product 104 may not bind to the material of the netting 102—either before or during cooking—as strongly as it otherwise would have without the denaturing effects of the acid. In other words, the mechanical adhesion between the food product 104 and the netting 102 may be lessened due to the effects of the acid of the release agent with which the netting 102 was treated. Therefore, release of the netting 102 from the food product 104 (e.g., after drying, cooking, showering, chilling, etc.) may be eased.

The acid may be one or more natural, organic acid. In some embodiments, the acid, or acids, may be selected from the group consisting of vinegar, citric acid, acetic acid (e.g., glacial acetic acid), sorbic acid, formic acid, propionic acid, maleic acid, and a mixture of any of the foregoing. For example, the at least one acid may be selected from the group consisting of vinegar (e.g., at about 5% acidity), citric acid, acetic acid (e.g., glacial acetic acid (e.g., at about 95% acidity)), formic acid, propionic acid, and maleic acid.

The acid, or acids, may be of relatively-weak acidity. Water or another buffer may be added to the acid to tailor the pH and acid level of the resulting release agent composition. In embodiments in which water is added to the acid, the aforementioned percentages represent the post-water-addition percentages of the acid component within the release agent composition. The resulting pH of the release agent may be in the range of about 2.5 to about 8.0.

The release agent may comprise between about 10 wt. % to about 85 wt. % (e.g., between about 25 wt. % to about 50 wt. %) (e.g., about 30 wt. %) of at least one acid, wherein these weight percentages are based on the weight of the release agent composition. For example, the release agent may comprise 30 wt. % acid component, and the acid component may be made up of acetic acid via natural 10% (100 grain) vinegar at a level of 4.9% acetic acid. As yet another example, the release agent may comprise more than one acid, e.g., about 49 wt. % vinegar (100 grain) and about 25 wt. % citric acid (e.g., anhydrous citric acid), again with these weight percentages based on the weight of the release agent composition. The amount of the acid within the release agent may be at least 10 wt. % to enable the acid component to effectively denature the proteins on the outer surface 106 of the food product 104. The amount of the acid within the release agent may be less than 85 wt. % to ensure the release agent does not impart a harsh (e.g., acid, metallic) flavor to the food product 104 or damage the material of the netting 102.

Oil:

In embodiments in which the release agent comprises an oil component, the oil component may serve to further ease release of the netting 102 from the food product 104 (e.g., after cooking, e.g., after post-cook showering).

The oil may comprise, consist essentially of or consist of at least one edible, food-compatible oil selected from the group consisting of edible mineral oil, paraffin, vegetable oil (e.g., soy oil (e.g., soybean oil), canola oil, corn oil, rapeseed oil, flaxseed oil), sunflower oil, palm oil, coconut-based oil (e.g., coconut oil), the like, and a mixture of any of the foregoing. In some embodiments, the oil may be free of BHT (butylated hydroxytoluene). The oil may be selected to ensure the release agent will not become rancid during the desired shelf-life of the treated netting or of the netted food product 100.

In embodiments in which the release agent composition comprises oil, the release agent composition may comprise about 5 wt. % to about 25 wt. % (e.g., about 7.5 wt. % to about 15 wt. %) (e.g., about 8 wt. %) oil, wherein these weight percentages are based on the weight of the release agent composition. For example, the release agent composition may comprise about 8 wt. % mineral oil. In some embodiments, the release agent composition may comprise at least 5 wt. % oil to effectively enhance the release of the netting 102 from the food product 104, e.g., during post-cook showering of the food product 104 while it is in the netting 102.

Surfactant:

The surfactant of the release agent composition may be an emulsifying agent enabling the emulsification of the hydrophilic (e.g., acid) and hydrophobic (e.g., oil, if included, and lecithin, if included) components of the release agent into a stable emulsion that can then be used in commercial equipment to load the netting 102 with the release agent. Without the inclusion of the surfactant, the components of the release agent mixture may form a two-phase blend that may result in an inhomogeneous coating of the netting 102. With the surfactant in the release agent composition, the release agent may be formed as a stable (e.g., as a mixture that does not separate, readily, upon standing), smooth (e.g., substantially uniform and consistent without agglomerates), and high-viscosity emulsion.

The at least one surfactant may each be selected from the group consisting of polysorbates (e.g., polyoxyethylene sorbate, i.e., polysorbate 80 (also known in the art as TWEEN® 80)), polyoxyethylene ethers (e.g., BRIJ®), sorbitan esters (e.g., SPAN®), lecithins (e.g., a lecithin derived from soy, sunflower, or the like), the like, and a mixture of any of the foregoing.

The release agent composition may comprise about 5 wt. % to about 15 wt. % (e.g., about 7 wt. % to about 10 wt. %) (e.g., about 8 wt. %) of at least one surfactant, wherein these weight percentages are based on the weight of the release agent composition. For example, the release agent composition may comprise about 8 wt. % polysorbate 80 (e.g., TWEEN® 80). The release agent composition may comprise at least 5 wt. % surfactant to provide a stable, smooth, emulsion, while comprising less than 15 wt. % surfactant to avoid waste of the surfactant material.

Surface Active Amphiphilic Modifier:

The surface amphiphilic modifier (e.g., the lecithin) of the release agent composition is amphiphilic and—in place on the netting 102—may provide a hydrophobic characteristic to the fibers of the netting 102. For example, the surface amphiphilic modifier may bind to the hydrophilic surface of the material of the netting 102, rendering the material locally hydrophobic. This hydrophobic characteristic may inhibit (e.g., slow or prevent) intrusion of food proteins (e.g., hydrophilic food proteins) from the food product 104 into the netting 102, additionally enabling an easy release between the netting 102 treated with the release agent and the underlying food product 104. Without the surface amphiphilic modifier, the netting 102 may be hydrophilic, such that it may more strongly bind with the hydrophilic proteins of the food product 104 and inhibit easy release of the netting from the food product.

The at least one surface active amphiphilic modifier may be one or more food-grade lecithins (e.g., a lecithin derived from soy, sunflower, or the like). In some embodiments, the lecithin may be a non-soy derivative to ensure the release agent composition contains no soy allergens.

The release agent composition may comprise about 5 wt. % to about 25 wt. % (e.g., about 7.5 wt. % to about 15 wt. %) (e.g., about 8 wt. %) of at least one surface active amphiphilic modifier, wherein these weight percentages are based on the weight of the release agent composition. For example, the release agent composition may comprise about 8 wt. % sunflower lecithin.

In some embodiments, the release agent composition may comprise both at least one surfactant component and at least one other component serving as the surface active amphiphilic modifier. For example a polysorbate may serve as the surfactant component while a lecithin may serve as the surface active amphiphilic modifier. However, in other embodiments, a single ingredient may serve a dual function of surfactant and surface active amphiphilic modifier. For example, lecithin may exhibit the characteristics of a surfactant (e.g., an emulsifier) while also increasing the surface hydrophobicity of the material of the netting 102 by binding to the surface of the netting 102. Therefore, the at least one surfactant and the at least one surface active amphiphilic modifier, discussed herein, may comprise the same ingredient (e.g., compound) or may comprise different ingredients (e.g., compounds).

Thickening Agent:

In some embodiments, the release agent may comprise a thickening agent. In other embodiments, the release agent may be free of a thickening agent.

The thickening agent may, optionally, be included to tailor the viscosity of the release agent composition with consideration to how absorbent and/or adsorbent the material of the netting 102 is. With the release agent composition being of a high enough viscosity, the acid component of the release agent may be absorbed, adsorbed, or otherwise held and maintained in place on the fibers of the netting 102 so as to be exposed to the outer surface 106 of the food product 104 once the food product 104 is inserted within the netting 102. Correspondingly, if the viscosity of the release agent is too low, or if the material of the netting 102 is relatively non-absorbent or non-adsorbent, the release agent composition may not be retained sufficiently in or on the fibers of the netting 102 such that the surface of the netting 102 will not contain enough of the acid and/or other components of the release agent to effectively treat the outer surface 106 of the food product 104.

In some embodiments, no separate thickening agent may be included in the release agent, such as in embodiments in which the material of the netting 102 is highly absorbent or adsorbent (e.g., a natural cotton fabric, e.g., a cotton stockinette netting material), in embodiments in which the structure of the material of the netting 102 is such as to provide a high amount of surface area interaction between the material of the netting 102 and the outer surface 106 of the food product 104 (e.g., a closed-type (e.g., stockinette, bubble) netting structure), and/or in embodiments in which the other components of the release agent provide a sufficient viscosity for ensuring the netting 102 retains or holds the release agent along the surface of the netting 102 material to ensure contact between at least the acid of the release agent composition and the proteins of the outer surface 106 of the food product 104.

In other embodiments-such as in embodiments using a relatively less-absorbent or less-adsorbent netting material (e.g., polyester netting material), in embodiments using a netting material providing relatively less surface area contact between netting 102 material and food product 104 (e.g., open-type netting), and/or in embodiments in which the other components of the release agent provide relatively low viscosity, the thickening agent may be included to tailor (e.g., increase) the viscosity of the release agent composition to be high enough to aid in the application and maintenance of the release agent on and/or in the fine fiber structures of the netting 102, enabling greater absorption and/or adsorption of the release agent composition in and/or on the material of the netting 102 than may otherwise be achieved with a lower viscosity composition. Thus, the thickening agent may enable the outer surface 106 of the food product 104 to be exposed to a sufficient amount of the protein-denaturizing acid component of the release agent.

The at least one thickening agent may be a gum (e.g., a natural gum thickener, xanthan gum, cellulose gum (e.g., carboxymethyl cellulose (CMC) gum)), carrageenan, pectin, gelatin, or the like.

In embodiments in which the release agent comprises a thickening agent, the release agent may comprise up to about 5 wt. % (e.g., between about 1.0 wt. % to about 3.0 wt. %) (e.g., about 1.6 wt. %) of at least one thickening agent, wherein these weight percentages are based on the weight of the release agent composition. For example, the release agent may comprise 1.6 wt. % xanthan gum. The release agent component may comprise less than about 5 wt. % thickening agent to enable the release agent composition to be mixable and successfully applied to the netting 102 (e.g., for the release agent to thoroughly penetrate the material of the netting 102), particularly in embodiments in which greater than about 5 wt. % thickening agent may make the release agent like a gel or solid not suitable for coating or even application to the netting 102.

Additional Additives:

Additional additives may be included in the release agent composition so as to tailor the release agent composition to desirable performance standards. For example, the release agent may comprise at least one flavorant and/or colorant, e.g., a liquid smoke, a caramel, paprika, spices, spice extracts, sulfates, sulfites, or the like. The amount of such additional additives may be tailored according to the desired parameters (e.g., flavor, color) of the food product 104. The release agent may be formulated to ensure transfer of the flavorant and/or colorant additives from the release agent in the netting 102 to the food product 104, itself. In some embodiments, the release agent composition may comprise between about 10 wt. % and about 30 wt. % aqueous liquid smoke flavoring, wherein these weight percentages are based on the weight of the release agent composition.

The release agent composition may be formed by mixing each of the components together to form a single mixture (e.g., emulsion) of the components. The release agent composition may be applied to the netting 102 as this one composition.

In other embodiments, the components of the release agent composition may be separately applied, either individually or in sub-groups, to the netting 102, such that the release agent composition of all of its components is not formed until all of the components have been applied to the netting 102. For example, the hydrophobic components of the release agent composition may first be applied to the netting 102, then the hydrophilic components may be applied.

To form the release agent composition as a single mixture (e.g., emulsion), each of the components of the release agent may be mixed together, e.g., at room temperature and at high shear (e.g., fast mixing rates), prior to application of the release agent to the material of the netting 102. In some such embodiments, the hydrophilic components may be mixed together before the hydrophobic components are added. For example, the one or more acids and the thickening agent (if the release agent is to include a thickening agent) may be mixed together at a high shear rate to form an aqueous solution thereof. If the release agent composition is to comprise more than one acid, the thickening agent may be added to one or more of the acids before others of the acids are added; or, alternatively, the thickening agent may be added after all of the acids have been mixed together.

The surfactant (if its function is not to be performed by the same component that is formulated to serve as the surface active amphiphilic modifier) may be added to the mixture of the hydrophilic components. In other embodiments, the surfactant (if a separate ingredient from the surface active amphiphilic modifier) may be included with the hydrophobic components or, otherwise, may not be added until after the hydrophobic components have been added.

Before, after, or simultaneously to forming the mixture of the hydrophilic components (either with or without the surfactant), the hydrophobic components may be mixed. In some embodiments, the hydrophobic materials may be heated (e.g., to about 60° C.) before, during, and/or after mixing. For example, in embodiments in which the release agent comprises oil, the oil may be heated (e.g., to about 60° C.) before and while adding the surface active amphiphilic modifier (e.g., the lecithin), which may be in solid powder form, initially.

To form the mixture of hydrophobic components, the oil (if included), and the surface active amphiphilic modifier (e.g., lecithin) may be mixed together, e.g., at an about 1:1 ratio. In embodiments in which the oil is included, the final release agent composition may comprise about 10 wt. % to about 50 wt. % (e.g., about 15 wt. % to about 30 wt. %) (e.g., about 16 wt. %) of the oil and surface active amphiphilic modifier mixture. For example, a 50:50 mixture of sunflower lecithin may be mixed with mineral oil, which mixture may be added to the other components of the release agent composition to make up about 16 wt. % of the release agent composition. In other embodiments, the mixture of hydrophobic components may be formed by mixing the surface active amphiphilic modifier (e.g., lecithin) with at least one surfactant and the oil (if included).

The mixture of the hydrophobic materials may be added to the mixture of hydrophilic components (which may already contain the surfactant, if the surface active amphiphilic modifier is not formulated to provide the dual function as a surfactant too) to form the final release agent composition, as a stable emulsion, before the release agent is applied to the netting 102. With the release agent formulated according to composition embodiments described herein, formed according to method embodiments described herein, and applied to the netting according to method embodiments herein enables subsequent fast, efficient, and clean release of the netting from cooked food products.

While the disclosed compositions, articles, and methods are susceptible to various modifications and alternative forms in implementation thereof, specific embodiments have been shown by way of example in the drawings and have been described in detail herein. However, it should be understood that the present invention is not intended to be limited to the particular forms disclosed. Rather, the present invention encompasses all modifications, combinations, equivalents, variations, and alternatives falling within the scope of the present disclosure as defined by the following appended claims and their legal equivalents.

1. A composition for a release agent for food netting, the composition comprising:
at least one acid; and
at least one of a surface active amphiphilic modifier or a surfactant.

2. The composition of claim 1, further comprising a thickening agent.

3. The composition of claim 1, wherein the at least one acid is selected from the group consisting of vinegar, citric acid, acetic acid, sorbic acid, formic acid, propionic acid, maleic acid, and a mixture of any thereof.

4. The composition of claim 1, wherein the at least one of the surface active amphiphilic modifier or the surfactant comprises lecithin.

5. The composition of claim 1, wherein the composition comprises a surface active amphiphilic modifier.

6. The composition of claim 5, wherein the surface active amphiphilic modifier comprises lecithin.

7. The composition of claim 1, wherein the composition comprises a surfactant.

8. The composition of claim 7, wherein the surfactant is selected from the group consisting of polysorbate(s), polyoxyethylene ether(s), sorbitan ester(s), lecithin, and a mixture of any thereof.

9. The composition of claim 1, further comprising at least one oil.

10. The composition of claim 9, wherein the at least one oil is selected from the group consisting of edible mineral oil, paraffin, soybean oil, canola oil, corn oil, rapeseed oil, flaxseed oil, sunflower oil, palm oil, coconut oil, and a mixture of any thereof.

11. A treated netting for food products, the treated netting comprising:
a netting material; and
a composition on or in the netting material, the composition comprising:
at least one acid; and
at least one of a surface active amphiphilic modifier or a surfactant.

12. The treated netting of claim 11, wherein, of a weight of the treated netting, the composition provides at least one times the weight of the netting material.

13. The treated netting of claim 11, wherein the composition further comprises at least one oil.

14. A method for treating a food netting with a release agent, the method comprising applying the composition of claim 1 on material of a food netting before receiving a food product within the food netting.

15. The method of claim 14, wherein the food netting is an open-type food netting, and the composition further comprises a thickening agent.

16. The method of claim 14, wherein the food netting is a closed-type food netting.

17. The method of claim 14, wherein applying the composition of claim 1 on the material of the food netting comprises loading the food netting with an amount of the composition at least equal to an initial weight of the food netting.

18. The method of claim 14, wherein the composition further comprises at least one oil.

19. A method for forming a release agent for food netting, the method comprising:
forming a mixture of hydrophilic components comprising at least one acid;
forming a mixture of hydrophobic components comprising at least one surface active amphiphilic modifier; and
combining the mixture of hydrophilic components with the mixture of hydrophobic components to form an emulsion of release agent.

20. The method of claim 19, wherein forming the mixture of hydrophobic components comprises combining the at least one surface active amphiphilic modifier and at least one oil.

21. The method of claim 19, wherein forming the mixture of hydrophobic components comprises combining the at least one surface active amphiphilic modifier and at least one surfactant.
